(19) United States
(12) Patent Application Publication
(10) Pub. No.: US 2015/0271599 A1
(43) Pub. Date: Sep. 24, 2015

(54) SHARED AUDIO SCENE APPARATUS

(71) Applicants: Juha Petteri OJANPERA, (US); NOKIA CORPORATION, Espoo (FI)

(72) Inventor: Juha Petteri Ojanpera, Nokia (FI)

(21) Appl. No.: 14/441,631

(22) PCT Filed: Nov. 12, 2012
(86) PCT No.: PCT/IB2012/056357

§ 371 Date: May 8, 2015

(51) Int. Cl. H04R 3/00; G01S 3/80

(52) U.S. Cl. CPC H04R 3/005; G01S 3/8006

(57) ABSTRACT

An apparatus comprising an input configured to receive an audio signal comprising at least two audio shots separated by an audio shot boundary, and a comparator configured to compare the audio signal against a reference audio signal and to determine a location of the audio shot boundary within the audio signal based on the comparison of the audio signal against the reference audio signal.

### FIELD

The present application relates to apparatus for the processing of audio and additionally audio-video signals to enable sharing of audio scene captured audio signals. The invention further relates to, but is not limited to, apparatus for processing audio and additionally audio-video signals to enable sharing of audio scene captured audio signals from mobile devices.

### BACKGROUND

Viewing recorded or streamed audio-video or audio content is well known. Commercial broadcasters covering an event often have more than one recording device (video-camera/microphone) and a programme director will select a ‘mix’ where an output from a recording device or combination of recording devices is selected for transmission.

Multiple ‘feeds’ may be found in sharing services for video and audio signals (such as those employed by YouTube). Such systems, which are known and are widely used to share user generated content recorded and uploaded or up-streamed to a server and then downloaded or down-streamed to a viewing/listening user. Such systems rely on users recording and uploading or up-streaming a recording of an event using the recording facilities at hand to the user. This may typically be in the form of the camera and microphone arrangement of a mobile device such as a mobile phone.

Often the event is attended and recorded from more than one position by different recording users at the same time. The viewing/listening end user may then select one of the up-streamed or uploaded data to view or listen.

### SUMMARY

Aspects of this application thus provide a shared audio capture for audio signals from the same audio scene whereby multiple devices or apparatus can record and combine the audio signals to permit a better audio listening experience.

There is provided according to a first aspect an apparatus comprising at least one processor and at least one memory including computer code for one or more programs, the at least one memory and the computer code configured to with the at least one processor cause the apparatus to at least perform: receive an audio signal comprising at least two audio shots separated by an audio shot boundary; compare the audio signal against a reference audio signal; and determine a location of the audio shot boundary within the audio signal based on the comparison of the audio signal against the reference audio signal.

The apparatus may be further caused to divide the audio signal at the location of the audio shot boundary to form two separate audio signal parts.

The apparatus may be further caused to align at least one of the two separate audio signal parts based on the reference audio signal to generate a common time line model.

Comparing the audio signal against a reference audio signal may cause the apparatus to select a reference audio signal from at least one of: a verified audio signal located on a common time line; and an initial audio signal for defining a common time line.

Comparing the audio signal against a reference audio signal may cause the apparatus to: align the start of the audio signal against the reference audio signal; generate from the audio signal an audio signal segment; determine a correlation value by correlating the audio signal segment against an aligned part of the reference audio signal.

Determining a location of the audio shot boundary within the audio signal based on the comparison of the audio signal against the reference audio signal may cause the apparatus to determine a shot boundary location within the audio signal segment where the correlation value differs significantly from a further correlation value determined by correlating the previous audio signal segment against an aligned part of the reference audio signal.

The correlation value may differ significantly from a further correlation value determined by correlating the previous audio signal segment against an associated aligned part of the reference audio signal where: the correlation value indicates the audio signal segment is correlated with the aligned part of the reference signal and the further correlation value indicates the previous audio signal segment is uncorrelated with the associated aligned part of the reference signal, or the correlation value indicates the audio signal segment is uncorrelated with the aligned part of the reference signal and the further correlation value indicates the previous audio signal segment is correlated with the associated aligned part of the reference signal.

Determining a location of the audio shot boundary within the audio signal based on the comparison of the audio signal against the reference audio signal may cause the apparatus to: divide the audio signal segment into two parts; determine a first part correlation value by correlating a first part audio signal segment against an associated aligned part of the reference audio signal; determine the audio shot boundary location is within the first part audio signal segment where at least one of the following is true: the first part correlation value indicates the first part audio signal segment is uncorrelated with the associated aligned part of the reference audio signal and the audio segment is uncorrelated with the aligned part of the reference audio signal; and the first part correlation value indicates the first part audio signal segment is correlated with the associated aligned part of the reference audio signal and the audio segment is correlated with the aligned part of the reference audio signal; and determine the audio shot boundary location is within a second part audio signal segment otherwise.

The apparatus may be further caused to: divide the audio signal segment part within which the audio shot boundary location is determined into two further parts; determine a first further part correlation value by correlating a first further part audio signal segment against an associated aligned part of the reference audio signal; determine the audio shot boundary location is within the first further part audio signal segment where at least one of the following is true: the first further part correlation value indicates the first further part audio signal segment is uncorrelated with the associated aligned part of the reference audio signal and the audio segment is uncorrelated with the aligned part of the reference audio signal; and the first further part correlation value indicates the first further part audio signal segment is correlated with the associated aligned part of the reference audio signal and the audio segment is correlated with the aligned part of the reference audio signal; and determine the audio shot boundary location is within a second further part audio signal segment otherwise; and repeat until the apparatus is caused to determine the size of the first part audio signal segment is smaller than a location duration threshold.

According to a second aspect there is provided a method comprising: receiving an audio signal comprising at least two audio shots separated by an audio shot boundary; comparing the audio signal against a reference audio signal; and determining a location of the audio shot boundary within the audio signal based on the comparison of the audio signal against the reference audio signal.

The method may further comprise dividing the audio signal at the location of the audio shot boundary to form two separate audio signal parts.

The method may further comprise aligning at least one of the two separate audio signal parts based on the reference audio signal to generate a common time line model.

Comparing the audio signal against a reference audio signal may comprise selecting a reference audio signal from at least one of: a verified audio signal located on a common time line; and an initial audio signal for defining a common time line.

Comparing the audio signal against a reference audio signal may comprise: aligning the start of the audio signal against the reference audio signal; generating from the audio signal an audio signal segment; and determining a correlation value by correlating the audio signal segment against an aligned part of the reference audio signal.

Determining a location of the audio shot boundary within the audio signal based on the comparison of the audio signal against the reference audio signal may comprise determining a shot boundary location within the audio signal segment where the correlation value differs significantly from a further correlation value determined by correlating the previous audio signal segment against an aligned part of the reference audio signal.

Determining a shot boundary location within the audio signal segment where the correlation value differs significantly from a further correlation value determined by correlating the previous audio signal segment against an associated aligned part of the reference audio signal may comprise determining: the correlation value indicates the audio signal segment is correlated with the aligned part of the reference signal and the further correlation value indicates the previous audio signal segment is uncorrelated with the associated aligned part of the reference signal, or the correlation value indicates the audio signal segment is uncorrelated with the aligned part of the reference signal and the further correlation value indicates the previous audio signal segment is correlated with the associated aligned part of the reference signal.

Determining a location of the audio shot boundary within the audio signal based on the comparison of the audio signal against the reference audio signal may comprise: dividing the audio signal segment into two parts; determining a first part correlation value by correlating a first part audio signal segment against an associated aligned part of the reference audio signal; determining the audio shot boundary location is within the first part audio signal segment where at least one of the following is true: the first part correlation value indicates the first part audio signal segment is uncorrelated with the associated aligned part of the reference audio signal and the audio segment is uncorrelated with the aligned part of the reference audio signal; and the first part correlation value indicates the first part audio signal segment is correlated with the associated aligned part of the reference audio signal and the audio segment is correlated with the aligned part of the reference audio signal; and determining the audio shot boundary location is within a second part audio signal segment otherwise.

The method may further comprise: dividing the audio signal segment part within which the audio shot boundary location is determined into two further parts; determining a first further part correlation value by correlating a first further part audio signal segment against an associated aligned part of the reference audio signal; determining the audio shot boundary location is within the first further part audio signal segment where at least one of the following is true: the first further part correlation value indicates the first further part audio signal segment is uncorrelated with the associated aligned part of the reference audio signal and the audio segment is uncorrelated with the aligned part of the reference audio signal; and the first further part correlation value indicates the first further part audio signal segment is correlated with the associated aligned part of the reference audio signal and the audio segment is correlated with the aligned part of the reference audio signal; and determine the audio shot boundary location is within a second further part audio signal segment otherwise; and repeat until the determining the size of the first part audio signal segment is smaller than a location duration threshold.

According to a third aspect there is provided an apparatus comprising: means for receiving an audio signal comprising at least two audio shots separated by an audio shot boundary; means for comparing the audio signal against a reference audio signal; and means for determining a location of the audio shot boundary within the audio signal based on the comparison of the audio signal against the reference audio signal.

The apparatus may further comprise means for dividing the audio signal at the location of the audio shot boundary to form two separate audio signal parts.

The apparatus may further comprise means for aligning at least one of the two separate audio signal parts based on the reference audio signal to generate a common time line model.

The means for comparing the audio signal against a reference audio signal may comprise means for selecting a reference audio signal from at least one of: a verified audio signal located on a common time line; and an initial audio signal for defining a common time line.

The means for comparing the audio signal against a reference audio signal may comprise: means for aligning the start of the audio signal against the reference audio signal; means for generating from the audio signal an audio signal segment; and means for determining a correlation value by correlating the audio signal segment against an aligned part of the reference audio signal.

The means for determining a location of the audio shot boundary within the audio signal based on the comparison of the audio signal against the reference audio signal may comprise means for determining a shot boundary location within the audio signal segment where the correlation value differs significantly from a further correlation value determined by correlating the previous audio signal segment against an aligned part of the reference audio signal.

The means for determining a shot boundary location within the audio signal segment where the correlation value differs significantly from a further correlation value determined by correlating the previous audio signal segment against an associated aligned part of the reference audio signal may comprise means for determining the correlation value indicates the audio signal segment is correlated with the aligned part of the reference signal and the further correlation value indicates the previous audio signal segment is uncorrelated with the associated aligned part of the reference signal, or the correlation value indicates the audio signal segment is uncorrelated with the aligned part of the reference signal and the further correlation value indicates the previous audio signal segment is correlated with the associated aligned part of the reference signal.

The means for determining a location of the audio shot boundary within the audio signal based on the comparison of the audio signal against the reference audio signal may comprise: means for dividing the audio signal segment into two parts; means for determining a first part correlation value by correlating a first part audio signal segment against an associated aligned part of the reference audio signal; means for determining the audio shot boundary location is within the first part audio signal segment where at least one of the following is true: the first part correlation value indicates the first part audio signal segment is uncorrelated with the associated aligned part of the reference audio signal and the audio segment is uncorrelated with the aligned part of the reference audio signal; and the first part correlation value indicates the first part audio signal segment is correlated with the associated aligned part of the reference audio signal and the audio segment is correlated with the aligned part of the reference audio signal; and determining the audio shot boundary location is within a second part audio signal segment otherwise.

The apparatus may further comprise: means for dividing the audio signal segment part within which the audio shot boundary location is determined into two further parts; means for determining a first further part correlation value by correlating a first further part audio signal segment against an associated aligned part of the reference audio signal; means for determining the audio shot boundary location is within the first further part audio signal segment where at least one of the following is true: the first further part correlation value indicates the first further part audio signal segment is uncorrelated with the associated aligned part of the reference audio signal and the audio segment is uncorrelated with the aligned part of the reference audio signal; and the first further part correlation value indicates the first further part audio signal segment is correlated with the associated aligned part of the reference audio signal and the audio segment is correlated with the aligned part of the reference audio signal; and means for determining the audio shot boundary location is within a second further part audio signal segment otherwise; and means for repeating until the means for determining the size of the first part audio signal segment determine the first part audio signal segment is smaller than a location duration threshold.

According to a fourth aspect there is provided an apparatus comprising: an input configured to receive an audio signal comprising at least two audio shots separated by an audio shot boundary; and a comparator configured to compare the audio signal against a reference audio signal and to determine a location of the audio shot boundary within the audio signal based on the comparison of the audio signal against the reference audio signal.

The apparatus may further comprise a segmenter configured to divide the audio signal at the location of the audio shot boundary to form two separate audio signal parts.

The apparatus may further comprise a common timeline assignor configured to align at least one of the two separate audio signal parts based on the reference audio signal to generate a common time line model.

The comparator may be configured to select a reference audio signal from at least one of: a verified audio signal located on a common time line; and an initial audio signal for defining a common time line.

The apparatus may comprise: an aligner configured to align the start of the audio signal against the reference audio signal; a segmenter configured to generate from the audio signal an audio signal segment; and a correlator configured to determine a correlation value by correlating the audio signal segment against an aligned part of the reference audio signal.

The comparator may be configured to determine a shot boundary location within the audio signal segment where the correlation value differs significantly from a further correlation value determined by correlating the previous audio signal segment against an aligned part of the reference audio signal.

The comparator may be configured to determine a shot boundary within the segment where: the correlation value indicates the audio signal segment is correlated with the aligned part of the reference signal and the further correlation value indicates the previous audio signal segment is uncorrelated with the associated aligned part of the reference signal, or the correlation value indicates the audio signal segment is uncorrelated with the aligned part of the reference signal and the further correlation value indicates the previous audio signal segment is correlated with the associated aligned part of the reference signal.

The comparator may further control: the segmenter to divide the audio signal segment into two parts; the correlator to generate a first part correlation value by correlating a first part audio signal segment against an associated aligned part of the reference audio signal; and further be configured to determine the audio shot boundary location is within the first part audio signal segment where at least one of the following is true: the first part correlation value indicates the first part audio signal segment is uncorrelated with the associated aligned part of the reference audio signal and the audio segment is uncorrelated with the aligned part of the reference audio signal; and the first part correlation value indicates the first part audio signal segment is correlated with the associated aligned part of the reference audio signal and the audio segment is correlated with the aligned part of the reference audio signal; and determine the audio shot boundary location is within a second part audio signal segment otherwise.

The comparator may further control: the segmenter to divide the audio signal segment part within which the audio shot boundary location is determined into two further parts; the correlator to generate a first further part correlation value by correlating a first further part audio signal segment against an associated aligned part of the reference audio signal; and further be configured to determine the audio shot boundary location is within the first further part audio signal segment where at least one of the following is true: the first further part correlation value indicates the first further part audio signal segment is uncorrelated with the associated aligned part of the reference audio signal and the audio segment is uncorrelated with the aligned part of the reference audio signal; and the first further part correlation value indicates the first further part audio signal segment is correlated with the associated aligned part of the reference audio signal and the audio segment is correlated with the aligned part of the reference audio signal; and determine the audio shot boundary location is within a second further part audio signal segment otherwise; and further be configured to repeat until the comparator is configured to determine the size of the first part audio signal segment is smaller than a location duration threshold.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For better understanding of the present application, reference will now be made by way of example to the accompanying drawings in which:

FIG. 1 shows schematically a multi-user free-viewpoint service sharing system which may encompass embodiments of the application;

FIG. 2 shows schematically an apparatus suitable for being employed in embodiments of the application;

FIG. 3 shows schematically an example content co-ordinating apparatus according to some embodiments;

FIG. 4 shows a flow diagram of the operation of the example content co-ordinating apparatus shown in FIG. 3 according to some embodiments;

FIG. 5 shows an audio alignment example overview; and

FIGS. 6 to 9 show audio alignment examples according to some embodiments.

### EMBODIMENTS OF THE APPLICATION

The following describes in further detail suitable apparatus and possible mechanism for the provision of effective audio signal capture sharing. In the following examples, audio signals and audio capture signals are described. However it would be appreciated that in some embodiments the audio signal/audio capture is a part of an audio-video system.

The concept of this application is related to assisting in the production of immersive person-to-person communication and can include video. It would be understood that the space within which the devices record the audio signal can be arbitrarily positioned within an event space. The captured signals as described herein are transmitted or alternatively stored for later consumption where the end user can select the listening point based on their preference from the reconstructed audio space. The rendering part then can provide one or more down mixed signals from which the multiple recordings that correspond to the selective listening point. It would be understood that each recording device can record the event seen and upload or upstream the recorded content. The uploaded or upstream process can include implicitly positioning information about where the content is being recorded.

Furthermore an audio scene can be defined as a region or area within which a device or recording apparatus effectively captures the same audio signal. Recording apparatus operating within an audio scene and forwarding the captured or recorded audio signals or content to a co-ordinating or management apparatus effectively transmit many copies of the same or very similar audio signal. The redundancy of many devices capturing the same audio signal permits the effective sharing of the audio recording or capture operation.

Content or audio signal discontinuities can occur, especially when the recorded content is uploaded to the content server after some time the recording has taken place that the uploaded content represents an edited version rather than the actual recorded content. For example the user can edit any recorded content before uploading the content to the content server. The editing can for example involve removing unwanted segments from the original recording. The signal discontinuity can create significant challenges to the content server as typically an implicit assumption is made that the uploaded content represents the audio signal or clip from a continuous timeline. Where segments are removed (or added) after recording has ended then the continuity assumption or condition no longer holds for the particular content.

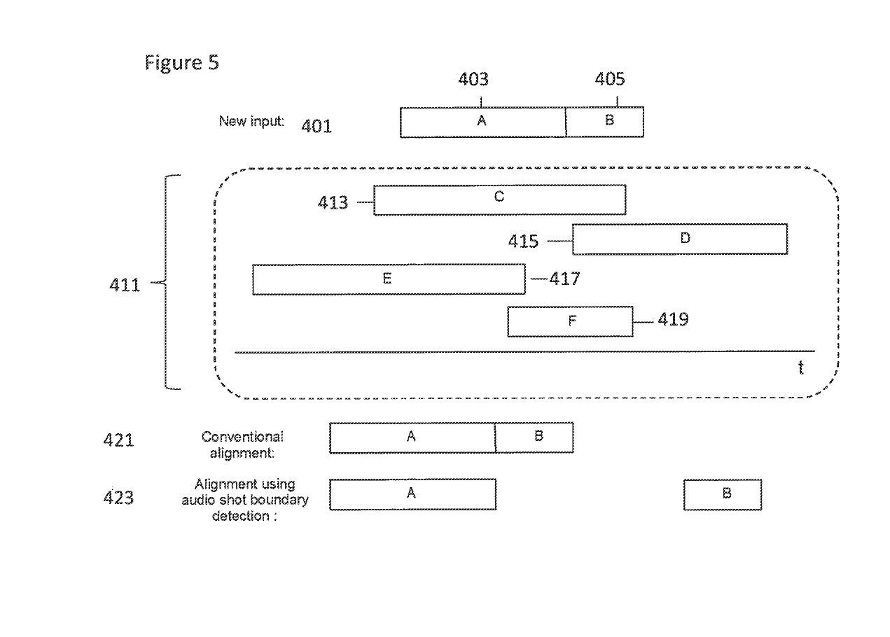

FIG. 5 illustrates the shot boundary problem in the multi-user environment. The common timeline comprises multi-user recorded content 411. The multi-user recorded content 411 comprises overlapping audio signals marked as audio signal C 413, audio signal D 415 which starts before the end of audio signal C 413, audio signal E 417 which starts before audio signal C 413 and ends before audio signal D 415 starts, and audio signal F 419 which starts before the end of audio signal C 413 and audio signal E 417 but before audio signal D 415 starts and ends after the end of audio signal C 413 and audio signal E 417 but before the end of audio signal D 415.

In the example shown in FIG. 5 new input content 401 is added to the multi-user environment. The new input audio signal 401 comprises two parts, audio signal A 403 and audio signal B 405, which do not represent continuous timeline audio signals, in other words the input content 401 is an edited audio signal where a segment or audio signal between the end of audio signal A 403 and the start of audio signal B 405 has been removed.

In a conventional alignment process such as shown in timeline 421, it is assumed that the content is continuous from start to the end, and, thus, aligns the entire content from the timestamp from the start of audio signal A 403. Furthermore where the duration of the audio signal B 405 segment is less than the duration of the audio signal A 403 segment, then it is more than likely that the entire content gets aligned based on the signal characteristics of segment A and the alignment process is not able to detect that segment B is actually a non-continuous part from segment A. Furthermore in some situations the alignment fails, due to the non-continuous timeline behaviour in which case the entire content is lost and content rendering cannot be applied in the multi-user content context.

In the embodiments as described herein the non-continuous boundary or shot can be detected within the content and both segments can be aligned to the common timeline such as shown by the alignment timeline 423 (or at least there would be no non-continuous content in the common timeline).

To create a downmixed signal from multi-user recorded content as discussed herein requires that all content is first converted to use the same timeline. The conversion typically occurs by synchronizing content before applying any cross-content processing related to the downmixing. However where the uploaded content does not represent a continuous timeline, synchronization fails to produce a common timeline for all of the content.

The purpose of the embodiments described herein is to describe apparatus and provide a method that decides or determines whether uploaded content is a combination of non-continuous (discontinuous) timelines and identifies any discontinuous or non-continuous timeline boundaries

The main challenge with current shot methods, which typically use video image detection, is that their accuracy in finding correct boundaries is limited and produce no guarantee that a proper shot boundary has been found. Furthermore, the main focus of the current methods is in detecting visual-scene boundaries and not in the boundaries related to non-continuous timeline. Furthermore they are focussed on single-user content and not multi-user content.

Thus embodiments as described herein describe apparatus and methods which address these problems and in some embodiment provide a recording or capture attempting to prevent misalignment of audio signals from the audio scene coverage. These embodiments outline methods for audio-shot boundary detection to identify non-continuous timeline segments in the uploaded content. The embodiments as discussed herein thus disclose methods and apparatus which create a common timeline from uploaded multi-user content, perform overlap-based correlation to locate non-continuous timeline boundaries, and create continuous timeline segments based on audio shot boundary detection.

Therefore in the embodiments described herein there are examples of shared or divided content audio scene recording method and apparatus for multi-user environments. The methods and apparatus describe the concept of aligning multi-source audio content by assigning a common timestamp value irrespective of discontinuous recorded material.

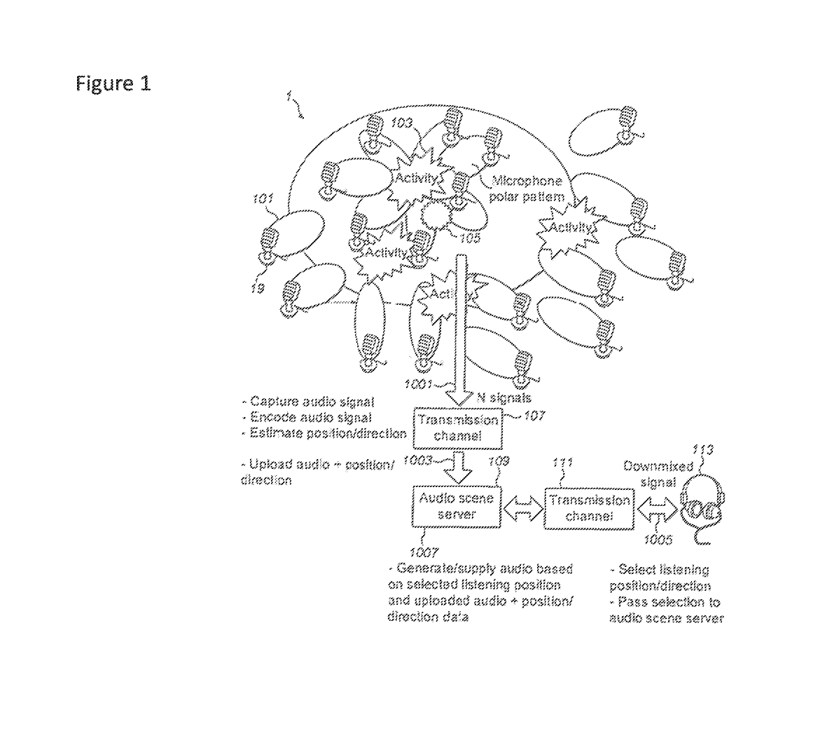

With respect to FIG. 1 an overview of a suitable system within which embodiments of the application can be located is shown. The audio space 1 can have located within it at least one recording or capturing device or apparatus 19 which are arbitrarily positioned within the audio space to record suitable audio scenes. The apparatus 19 shown in FIG. 1 are represented as microphones with a polar gain pattern 101 showing the directional audio capture gain associated with each apparatus. The apparatus 19 in FIG. 1 are shown such that some of the apparatus are capable of attempting to capture the audio scene or activity 103 within the audio space. The activity 103 can be any event the user of the apparatus wishes to capture. For example the event could be a music event or audio of a “news worthy” event. The apparatus 19 although being shown having a directional microphone gain pattern 101 would be appreciated that in some embodiments the microphone or microphone array of the recording apparatus 19 has a omnidirectional gain or different gain profile to that shown in FIG. 1.

Each recording apparatus 19 can in some embodiments transmit or alternatively store for later consumption the captured audio signals via a transmission channel 107 to an audio scene server 109. The recording apparatus 19 in some embodiments can encode the audio signal to compress the audio signal in a known way in order to reduce the bandwidth required in “uploading” the audio signal to the audio scene server 109.

The recording apparatus 19 in some embodiments can be configured to estimate and upload via the transmission channel 107 to the audio scene server 109 an estimation of the location and/or the orientation or direction of the apparatus. The position information can be obtained, for example, using GPS coordinates, cell-ID or a-GPS or any other suitable location estimation methods and the orientation/direction can be obtained, for example using a digital compass, accelerometer, or gyroscope information.

In some embodiments the recording apparatus 19 can be configured to capture or record one or more audio signals for example the apparatus in some embodiments have multiple microphones each configured to capture the audio signal from different directions. In such embodiments the recording device or apparatus 19 can record and provide more than one signal from different the direction/orientations and further supply position/direction information for each signal. With respect to the application described herein an audio or sound source can be defined as each of the captured or audio recorded signal. In some embodiments each audio source can be defined as having a position or location which can be an absolute or relative value. For example in some embodiments the audio source can be defined as having a position relative to a desired listening location or position. Furthermore in some embodiments the audio source can be defined as having an orientation, for example where the audio source is a beamformed processed combination of multiple microphones in the recording apparatus, or a directional microphone. In some embodiments the orientation may have both a directionality and a range, for example defining the 3 dB gain range of a directional microphone.

The capturing and encoding of the audio signal and the estimation of the position/direction of the apparatus is shown in FIG. 1 by step 1001.

The uploading of the audio and position/direction estimate to the audio scene server 109 is shown in FIG. 1 by step 1003.

The audio scene server 109 furthermore can in some embodiments communicate via a further transmission channel 111 to a listening device 113.

In some embodiments the listening device 113, which is represented in FIG. 1 by a set of headphones, can prior to or during downloading via the further transmission channel 111 select a listening point, in other words select a position such as indicated in FIG. 1 by the selected listening point 105. In such embodiments the listening device 113 can communicate via the further transmission channel 111 to the audio scene server 109 the request.

The selection of a listening position by the listening device 113 is shown in FIG. 1 by step 1005.

The audio scene server 109 can as discussed above in some embodiments receive from each of the recording apparatus 19 an approximation or estimation of the location and/or direction of the recording apparatus 19. The audio scene server 109 can in some embodiments from the various captured audio signals from recording apparatus 19 produce a composite audio signal representing the desired listening position and the composite audio signal can be passed via the further transmission channel 111 to the listening device 113.

The generation or supply of a suitable audio signal based on the selected listening position indicator is shown in FIG. 1 by step 1007.

In some embodiments the listening device 113 can request a multiple channel audio signal or a mono-channel audio signal. This request can in some embodiments be received by the audio scene server 109 which can generate the requested multiple channel data.

The audio scene server 109 in some embodiments can receive each uploaded audio signal and can keep track of the positions and the associated direction/orientation associated with each audio source. In some embodiments the audio scene server 109 can provide a high level coordinate system which corresponds to locations where the uploaded/upstreamed content source is available to the listening device 113. The “high level” coordinates can be provided for example as a map to the listening device 113 for selection of the listening position. The listening device (end user or an application used by the end user) can in such embodiments be responsible for determining or selecting the listening position and sending this information to the audio scene server 109. The audio scene server 109 can in some embodiments receive the selection/determination and transmit the downmixed signal corresponding to the specified location to the listening device. In some embodiments the listening device/end user can be configured to select or determine other aspects of the desired audio signal, for example signal quality, number of channels of audio desired, etc. In some embodiments the audio scene server 109 can provide in some embodiments a selected set of downmixed signals which correspond to listening points neighbouring the desired location/direction and the listening device 113 selects the audio signal desired.

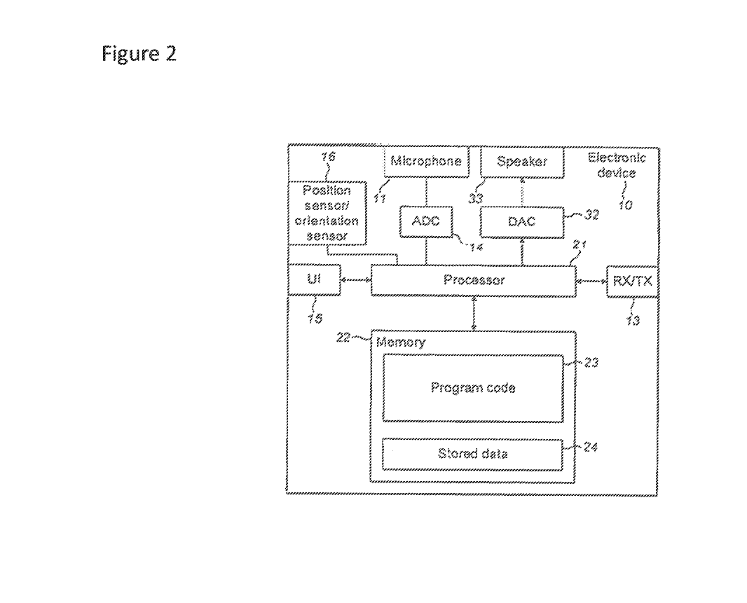

In this regard reference is first made to FIG. 2 which shows a schematic block diagram of an exemplary apparatus or electronic device 10, which may be used to record (or operate as a recording or capturing apparatus 19) or listen (or operate as a listening apparatus 113) to the audio signals (and similarly to record or view the audio-visual images and data). Furthermore in some embodiments the apparatus or electronic device can function as the audio scene server 109.

The electronic device 10 may for example be a mobile terminal or user equipment of a wireless communication system when functioning as the recording device or listening device 113. In some embodiments the apparatus can be an audio player or audio recorder, such as an MP3 player, a media recorder/player (also known as an MP4 player), or any suitable portable device suitable for recording audio or audio/video camcorder/memory audio or video recorder.

The apparatus 10 can in some embodiments comprise an audio subsystem. The audio subsystem for example can comprise in some embodiments a microphone or array of microphones 11 for audio signal capture. In some embodiments the microphone or array of microphones can be a solid state microphone, in other words capable of capturing audio signals and outputting a suitable digital format signal. In some other embodiments the microphone or array of microphones 11 can comprise any suitable microphone or audio capture means, for example a condenser microphone, capacitor microphone, electrostatic microphone, Electret condenser microphone, dynamic microphone, ribbon microphone, carbon microphone, piezoelectric microphone, or microelectrical-mechanical system (MEMS) microphone. The microphone 11 or array of microphones can in some embodiments output the audio captured signal to an analogue-to-digital converter (ADC) 14.

In some embodiments the apparatus can further comprise an analogue-to-digital converter (ADC) 14 configured to receive the analogue captured audio signal from the microphones and outputting the audio captured signal in a suitable digital form. The analogue-to-digital converter 14 can be any suitable analogue-to-digital conversion or processing means.

In some embodiments the apparatus 10 audio subsystem further comprises a digital-to-analogue converter 32 for converting digital audio signals from a processor 21 to a suitable analogue format. The digital-to-analogue converter (DAC) or signal processing means 32 can in some embodiments be any suitable DAC technology.

Furthermore the audio subsystem can comprise in some embodiments a speaker 33. The speaker 33 can in some embodiments receive the output from the digital-to-analogue converter 32 and present the analogue audio signal to the user. In some embodiments the speaker 33 can be representative of a headset, for example a set of headphones, or cordless headphones.

Although the apparatus 10 is shown having both audio capture and audio presentation components, it would be understood that in some embodiments the apparatus 10 can comprise one or the other of the audio capture and audio presentation parts of the audio subsystem such that in some embodiments of the apparatus the microphone (for audio capture) or the speaker (for audio presentation) are present.

In some embodiments the apparatus 10 comprises a processor 21. The processor 21 is coupled to the audio subsystem and specifically in some examples the analogue-to-digital converter 14 for receiving digital signals representing audio signals from the microphone 11, and the digital-to-analogue converter (DAC) 12 configured to output processed digital audio signals. The processor 21 can be configured to execute various program codes. The implemented program codes can comprise for example audio signal or content shot detection routines.

In some embodiments the apparatus further comprises a memory 22. In some embodiments the processor is coupled to memory 22. The memory can be any suitable storage means. In some embodiments the memory 22 comprises a program code section 23 for storing program codes implementable upon the processor 21. Furthermore in some embodiments the memory 22 can further comprise a stored data section 24 for storing data, for example data that has been encoded in accordance with the application or data to be encoded via the application embodiments as described later. The implemented program code stored within the program code section 23, and the data stored within the stored data section 24 can be retrieved by the processor 21 whenever needed via the memory-processor coupling.

In some further embodiments the apparatus 10 can comprise a user interface 15. The user interface 15 can be coupled in some embodiments to the processor 21. In some embodiments the processor can control the operation of the user interface and receive inputs from the user interface 15. In some embodiments the user interface 15 can enable a user to input commands to the electronic device or apparatus 10, for example via a keypad, and/or to obtain information from the apparatus 10, for example via a display which is part of the user interface 15. The user interface 15 can in some embodiments comprise a touch screen or touch interface capable of both enabling information to be entered to the apparatus 10 and further displaying information to the user of the apparatus 10.

In some embodiments the apparatus further comprises a transceiver 13, the transceiver in such embodiments can be coupled to the processor and configured to enable a communication with other apparatus or electronic devices, for example via a wireless communications network. The transceiver 13 or any suitable transceiver or transmitter and/or receiver means can in some embodiments be configured to communicate with other electronic devices or apparatus via a wire or wired coupling.

The coupling can, as shown in FIG. 1, be the transmission channel 107 (where the apparatus is functioning as the recording device 19 or audio scene server 109) or further transmission channel 111 (where the device is functioning as the listening device 113 or audio scene server 109). The transceiver 13 can communicate with further devices by any suitable known communications protocol, for example in some embodiments the transceiver 13 or transceiver means can use a suitable universal mobile telecommunications system (UMTS) protocol, a wireless local area network (LAN) protocol such as for example IEEE 802.X, a suitable short-range radio frequency communication protocol such as Bluetooth, or infrared data communication pathway ° RDA).

In some embodiments the apparatus comprises a position sensor 16 configured to estimate the position of the apparatus 10. The position sensor 16 can in some embodiments be a satellite positioning sensor such as a GPS (Global Positioning System), GLONASS or Galileo receiver.

In some embodiments the positioning sensor can be a cellular ID system or an assisted GPS system.

In some embodiments the apparatus 10 further comprises a direction or orientation sensor. The orientation/direction sensor can in some embodiments be an electronic compass, accelerometer, a gyroscope or be determined by the motion of the apparatus using the positioning estimate.

It is to be understood again that the structure of the electronic device 10 could be supplemented and varied in many ways.

Furthermore it could be understood that the above apparatus 10 in some embodiments can be operated as an audio scene server 109. In some further embodiments the audio scene server 109 can comprise a processor, memory and transceiver combination.

In the following examples there are described an audio scene/content recording or capturing apparatus which correspond to the recording device 19 and an audio scene/content co-ordinating or management apparatus which corresponds to the audio scene server 109. However it would be understood that in some embodiments the audio scene management apparatus can be located within the recording or capture apparatus as described herein and similarly the audio scene recording or content capture apparatus can be a part of an audio scene server 109 capturing audio signals either locally or via a wireless microphone coupling.

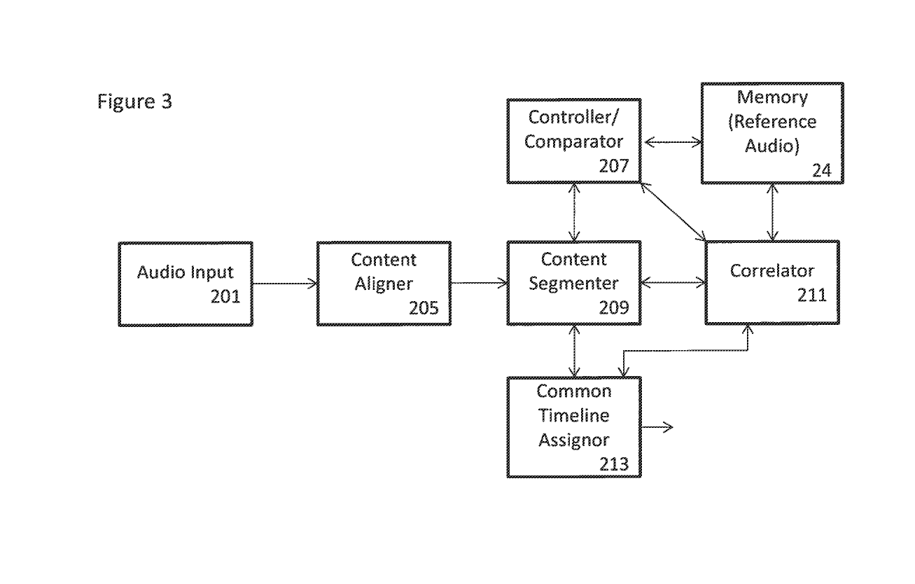

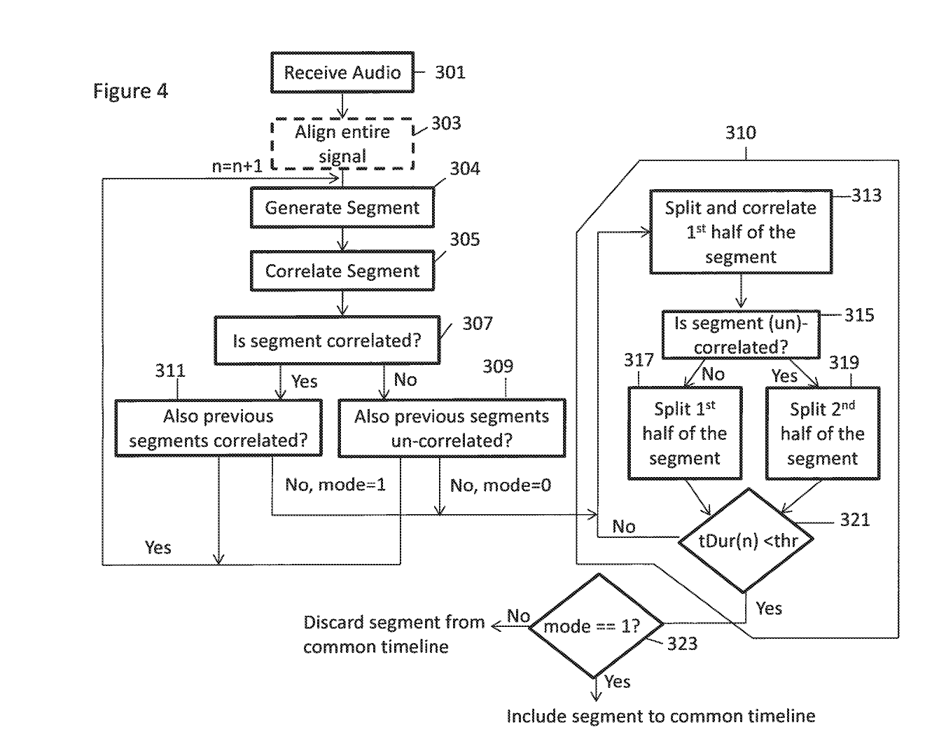

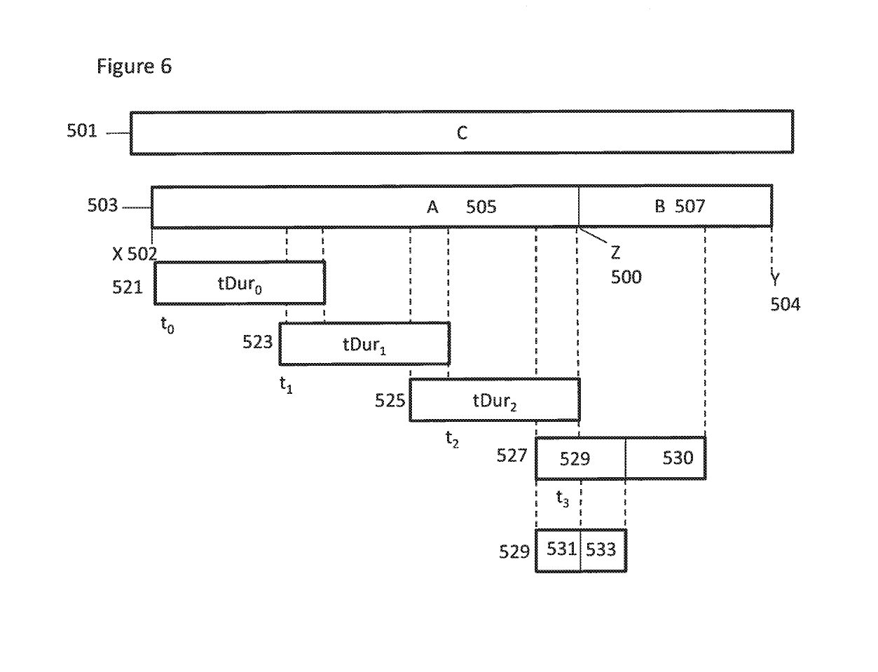

With respect to FIG. 3 an example content co-ordinating apparatus according to some embodiments is shown which can be implemented within the recording device 19, the audio scene server, or the listening device (when acting as a content aggregator). Furthermore FIG. 4 shows a flow diagram of the operation of the example content co-ordinating apparatus shown in FIG. 3 according to some embodiments. Furthermore the example result of the shot detection within the operation of the embodiments is shown with respect to FIG. 6.

The operation of the content co-ordinating apparatus can be summarised as the following table

| | |
|---|---|
| 1) | Select content (hereafter referred a X) that is not yet part of the |
| | common timeline |
| 2) | Align content X to the timeline. The actual alignment process may |
| | align the entire signal to the common timeline or at least a partial |
| | segment of content X is aligned (the unused segments get aligned |
| | implicitly since here it is assumed that the content represents |
| | continuous timeline) |
| 3) | Verify the timeline continuity of content X using the content |
| | signals from the common timeline as reference |
| 3.1) | For each segment window of content X find at least one reference |
| | content from the common timeline. The reference content must be |
| | overlapping with the specified segment window |
| 3.1.1) | The segments from content X that are not similar with any of the |
| | reference segments are excluded from the timeline |
| 3.1.2) | The segments of content X for which there is no overlapping |
| | reference segment found from the common timeline may also get |
| | excluded from the timeline |

In some embodiments the content coordinating apparatus comprises an audio input 201. The audio input 201 can in some embodiments be the microphone input, or a received input via the transceiver or other wire or wireless coupling to the apparatus. In some embodiments the audio input 201 is the memory 22 and in particular the stored data memory 24 where any edited or unedited audio signal is stored.

The operation of receiving the audio input is shown in FIG. 4 by step 301.

With respect to FIG. 6 the input audio signal 503 is shown with a start time value of T=x 502 and an end time value of T=y 504. Furthermore the input audio signal 503 comprises a first part or segment, segment A 505 which has a start time value of T=x 502 and an end time value of T=z 500, and a second part of segment, segment B 507 which has a start time value of T=z 500 and an end time value of T=y 504 (where T=z 500 is between T=x 502 and Thy 504). It would be understood that in the example created herein the two segments A and B are discontinuous or non-continuous in the time and also frequency domain.

In some embodiments the content coordinating apparatus comprises a content aligner 205. The content aligner 205 can in some embodiments receive the audio input signal and be configured (where the input signal is not originally) to align the input audio signal according to its initial time stamp value. In the following example the input audio signal has a start timestamp T=x and length or end time stamp T=y, in other words the input audio signal is defined by the pair wise value of (x, y).

In some embodiments the initial time stamp based alignment can be performed with respect to one or more reference audio content parts. In the example shown in FIG. 6 the input audio signal 503 is initial time stamp based aligned with the reference audio content or audio signal, segment C 501. In some embodiments the input audio signal is aligned against a reference audio content time stamp where both the input audio signal and reference audio signal are known to use a common clock time stamp. For example in some embodiments the recording of the audio signal can be performed with an initial time stamp provided the apparatus internal clock or a received clock signal, such as a cellular clock time stamp, a positioning or GPS clock time stamp or any other received clock signal.

The operation of initially aligning the entire input audio signal against a reference signal is shown in FIG. 4 by step 303.

In some embodiments the content coordinating apparatus comprises a content segmenter 209. The content segmenter 209 can be audio input 201 can in some embodiments be configured to generate an audio signal segment to be used for further processing.

In some embodiments the content segmenter 209 is configured to receive a segment counter value determining the start position of the segment and a segment window length. The segment counter value can in some embodiments be received from a controller 207 configured to control the operation of the content segmenter 209, correlator 211 and common timeline assigner 213.

The segments generated by the content segmenter 209 can in some embodiments be configured with a time period of tDur. Thus for example the initial content segment 521 can have a start time of T=t₀ (which in the example shown in FIG. 6 is also T=x), and have a duration of tDur₀. The duration time (tDur) of the segment window is implementation dependent issue but in some embodiments the window duration is preferably at least seconds, maybe even few tens of seconds long in order to obtain robust results. It would be understood furthermore that the content segmenter 209 is configured to generate overlapping segments. For example in some embodiments the controller is configured to indicate a second or further segment at a later start time of T=t₁ and have a duration of tDur₁, but where t₁ is less than t₀+tDur₀. For example in some embodiments the controller can be configured to perform a control loop where the loop starts at 0, n=0, and generate the nth segment start instant t₀ and length or duration tDurₙ. In some embodiments the overlap between successive windows can vary but is typically at least some seconds of overlap between successive segment windows are preferred.

The operation of segmenting the input audio signal is shown in FIG. 4 by step 304.

Furthermore with respect to FIG. 6 the initial or first segment 521 is shown with a start time of t₀ and duration of tDur₀, a second segment 523 is shown with a start time of t₁ and duration of tDur₁, a third segment 525 is shown with a start time of t₂ and duration of tDur₂, and a fourth segment 527 is shown with a start time of t₃ and duration of tDur₃.

The content segmenter 209 can in some embodiments be configured to output the segmented audio signal to the correlator 211.

In some embodiments the content coordinating apparatus comprises a correlator 211. The correlator 211 can be configured to receive the segment and correlate the segment, for example the first segment (t₀, t₀+tDur₀) 521 against the reference audio signal 503. In some embodiments the reference audio signal 503 can be stored or be retrieved from the memory 22 and in some embodiments the stored data section 24. In some embodiments all of the reference content that is overlapping with the segment is used as a reference segment. The output of the correlator 211 can in some embodiments be passed to the controller/comparator 211. The correlator 211 can be configured to determine any suitable correlation metric, for example time correlation, frequency correlation, or estimation comparison such as “G. C. Carter, A. H. Nutall, and P. G. Cable, The smoothed coherence transform, Proceedings of the IEEE, vol. 61, no. 10, pp. 1497-1498, 973” and “R. Cusani, Performance of fast time delay estimators, IEEE Trans. Acoustics, Speech, and Signal Processing, vol. 37, no. 5, pp. 757-759, 1989”, or any suitable audio similarity method.

The operation of correlating the segment against the reference audio signal is shown in FIG. 4 by step 307.

In some embodiments the content coordinating apparatus comprises a controller/comparator 207. The controller/comparator 207 can in some embodiments be configured to receive the output of the correlator 211 to determine whether the segment is correlated. In other words the controller/comparator 207 can be configured to determine if similar content to the segment content is found from the common timeline.

The operation of determining whether the segment is correlated is shown in FIG. 4 by step 309.

Furthermore the controller/comparator 207 examines the previous segment correlation results.

For example where the segment window is found similar (in other words correlated) then the controller/comparator 207 determines whether the previous segment also was correlated.

The operation of determining whether the previous segment was correlated dependent on the current segment was correlated is shown in FIG. 4 by step 311.

Where the previous segment was uncorrelated and the current segment is correlated then an iterative detection mode shown in FIG. 4 by step 310 is entered with a mode flag value set to 1.

Where the previous segment was correlated and the current segment is correlated then the controller/comparator 207 is configured to cause a further segment to be generated, in other words the current segment count is n=n+1, and the next segment with a start timestamp of T=tₙ₊₁ and duration tDurₙ₊₁ is generated.

This is shown in FIG. 4 as a loop back to step 304.

Similarly where the segment window is found dissimilar (in other words un-correlated) then the controller/comparator 207 determines whether the previous segment also was also un-correlated.

The operation of determining whether the previous segment was un-correlated dependent on the current segment was un-correlated is shown in FIG. 4 by step 309.

Where the previous segment was uncorrelated and the current segment is uncorrelated (i.e. the current segment is not correlated) then the controller/comparator 207 is configured to cause a further segment to be generated, in other words the current segment count is n=n+1, and the next segment with a start timestamp of T=tₙ₊₁ and duration tDurₙ₊₁ generated. This is shown in FIG. 4 as a loop back to step 304.

Where the previous segment was correlated (the previous segment is not uncorrelated) and the current segment is uncorrelated then an iterative detection mode shown in FIG. 4 by step 310 is entered with a mode flag value set to 0.

The purpose of the iterative detection mode is to locate the audio shot boundary more precisely in terms of the exact position. The idea in some embodiments as described herein is to narrow the possible position of the audio shot boundary by splitting the segment window in question into two on every iteration round. It would be understood that other segmentation search operations can be performed in some embodiments.

Thus in some embodiments the controller/comparator 207 can be configured to split the current segment duration into parts, for example halves.

This can for example be shown in FIG. 6 by the fourth segment 527, which overreaches from the first part A 505 to the second part B 507. The controller/comparator 207 having determined that the fourth segment 527 is uncorrelated, but the third segment 525 (which falls completely within the first part A 505) is correlated enters the iterative detection mode with mode flag set to 0. The controller/comparator 207 can be configured to split the fourth segment 527 into two halves a fourth segment first half 529 and a fourth segment second half 530.

For example assuming that the start time and duration of the n^{th} segment window entering the iterative detection mode is t(n) and tDur(n) respectively, the halving of the segment can be summarised mathematically as

$$tDur ( shot ) = \frac{tDur ( n )}{2} , {tShot}_{start} = t ( n ) , {tShot}_{end} = {tShot}_{start} + tDur ( shot )$$

The controller/comparator 207 can then control the correlator 211 to correlate the first half of the segment and receive the output of the correlator 211. This can mathematically be summarised as correlate segment window from tShotₛₜₐᵣₜ to tShot_{end} with tDurₛₗₒₜ=tShot_{end}−tShotₛₜₐᵣₜ

The operation of splitting and correlating the first half of the segment is shown in FIG. 4 by step 313.

The controller/comparator 207 can then be configured to determine whether the halved segment is correlated for a mode flag value of 1 or uncorrelated for a mode flag value of 0.

The operation of determining whether the segment half is correlated where the mode flag is set to 1 (or un-correlated where the mode flag is set to 0) is shown in FIG. 4 by step 315.

The controller/comparator 207, where the halved segment is correlated (and the mode flag is set to 1) or where the halved segment is uncorrelated (where the mode flag is set to 0), is configured to indicate that where there is a further halving it is to occur in the current halved segment. For example taking the example shown in FIG. 6 where the discontinuity falls within the fourth segment 527, and furthermore the fourth segment first half 529 then the controller/comparator 207 entering the iteration mode step 310 with a mode flag value of 0, would determine that the fourth segment first half 529 was uncorrelated, i.e. the discontinuity occurs within the fourth segment first half 529 and therefore to continue the search for the discontinuity within the first half 529.

This can be summarised matheatically as

If correlated (for mode==1)/un-correlated (mode==0):
Next split is to be 1^{st} half
i.e. next(tShotₛₜₐᵣₜ)=current(tShotₛₜₐᵣₜ),

The operation of determining the next split is a 1^{st} half split is shown in FIG. 4 by step 317.

Similarly should controller/comparator 207 determine that the halved segment is correlated (and the mode flag is set to 0) or where the halved segment is uncorrelated (where the mode flag is set to 1), the controller/comparator 207 can be configured to indicate that where there is a further halving it is to occur in the second halved segment.

If not correlated (for mode==1)/not un-correlated (mode==0):
Next split is 2^{nd} half
i.e. next(tShotₛₜₐᵣₜ)=current(tShotₛₜₐᵣₜ+0.51Durₛₕₒₜ)

The operation of determining the next split is a 2^{nd} half split is shown in FIG. 4 by step 319.

The controller/comparator 207 in some embodiments can further determine whether sufficient accuracy in the search has been achieved by checking the current shot duration (tDur(n) or tDurₛₕₒₜ) against a shot search duration threshold value (thr).

The operation of determining whether sufficient accuracy in the search has been achieved is shown in FIG. 4 by step 321.

Where the controller/comparator 207 determines that sufficient accuracy has not been achieved then the iteration detection mode loops back to the operation of splitting and correlating the 1^{st} half of the current shot or segment length.

This operation is shown in FIG. 4 by the loop back to step 313.

Where the controller/comparator 207 determines sufficient accuracy in the search has been achieved, in other words Our(n) is smaller than thr, the controller/comparator 207 can be configured to indicate that the audio shot boundary position has been found within a determined accuracy and the and the an iterative detection mode shown in FIG. 4 by step 310 is exited (in other words the calculation loop is terminated). The value of thr is the minimum segment window duration for the iterative detection mode. Typically the value of thr is set to a fraction of the original segment window duration. The position for the audio shot boundary is ten set as tShot_{end}.

The controller/comparator 207 in some embodiments can be configured to pass the current shot or segment location, duration, and mode value to a common timeline assignor 213.

In some embodiments the content coordinating apparatus comprises a common timeline assignor 213. The common timeline assignor 213 can be configured to receive the output of the iterative detection mode, in other words the current shot or segment location, duration and the mode value. The common timeline assignor 213 can thus in some embodiments once the position of the audio shot boundary has been found determine which segment from the input content should be kept in the timeline and which content should be excluded from the timeline.

For example in some embodiments the common timeline assignor 213 when determining the mode==0, can be configured to include content segment up to tShot_{end} to the timeline and content segment from tShot_{end} to the end of the content is excluded from the timeline.

In some embodiments the excluded content segment can then be used as a further input to the content aligner 205, in other words the operation loops back to step 303 using the excluded content.

In some embodiments the common timeline assignor 213 when determining the mode==1, can be configured to exclude content segment up to tShot_{end} from the common timeline and include the input content segment from tShot_{end} to the end of the content in the common timeline but with information that the continuity of the subsequent segments have not been yet verified.

In this case the unverified content segment can be used as an input to the content segmenter and correlator, in other words steps 304 and 305 in FIG. 4, in order to start a verification process. The excluded content segment in some embodiments can then be used as a further input to the content aligner 205, in other words the operation loops back to step 303 using the excluded content.

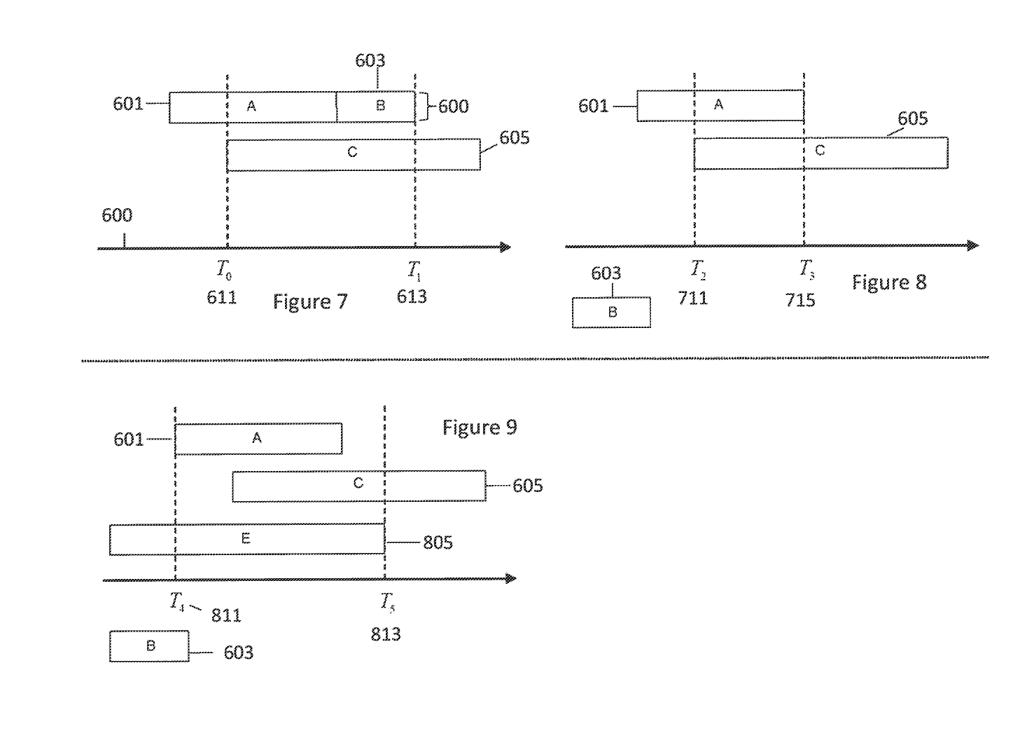

With respect to FIGS. 7 to 9 further illustrative examples of timelines of audio signal or content input according to some embodiments is shown.

With respect to FIG. 7, the input content audio signal (A+B) 600 comprising a first part A 601 and a second part B 603 are shown aligned against a reference audio signal or content C 605. In other words FIG. 7 shows an example timeline construction following the operation of the content aligner 205 having performed a first or initial alignment of the input content audio signal against a reference audio signal or content. This as shown in FIG. 2 results in a common timeline 600.

Furthermore according to the embodiments described herein the input content is segmented between T₀ 611 (the start of the reference audio signal—as the input audio signal starts before the start of the reference audio signal) and T₁ (the end of the input audio signal—as the input audio signal ends before the end of the reference audio signal). The segmentation, correlation and comparison results in the verification for timeline continuity as this is the time period where overlapping.

With respect to FIG. 8, the operation of the controller/comparator 207 and the correlator 211 and common timeline assignor 213 is shown where the audio shot boundary or discontinuity between the part A 601 and part B 603 is determined and the input audio or content for the time segment from T₂ 711 (which is equal to T₀) to T₃ 715 (the end of part A 601) is verified with no audio shot boundaries. The content segment part B 603 can be according to some embodiments as described herein to contain at least one audio shot boundary and is therefore excluded from the common timeline (for now).

The content segment from the start of content part A 601 to the start of content C 605 belongs to the common timeline but can be seen to not yet have been verified since there is no overlapping content for that period. The same is valid also for content C that covers period from the end of content part A to the end of content C.

With respect to FIG. 9 the verification of the audio signal in part A from the start of content part A 601 to the start of content C 605 and for content C that covers the period from the end of content part A to the end of content C is shown in the timeline where further new audio signal or content E 805 is added to the common timeline.

In this example the content coordinating apparatus determines that the Content part B 603 is still not part of the timeline as it does not align with any of the signals already in the common timeline. The content coordinating apparatus then can be configured to check or validate any content segments that have not yet been checked for timeline continuity using the audio shot detection method. According to the example shown in FIG. 9 these segments would be: Content segment A that covers period from the start of content A to the start of content C, content segment C that covers period from the end of segment A to the end of segment E, and content segment E that covers period from T₄ 811 (the start of content segment A) to T₅ 813 (the end of content segment E 805). In this example the content coordinating apparatus discovers no audio shot boundary or discontinuity in the segments and thus generates a resulting common timeline where all overlapping segments have been verified for the content segments from T₄ 811 (the start of content segment A) to T₅ 813 (the end of content segment E 805). It would be understood that the content segments that cover the periods from the start of content E to the start of content A, and from the end of content E to the end of content C still belong to the common timeline but those segments have yet to be verified for timeline continuity. This can happen once there is overlapping content available for those periods in the common timeline.

In some embodiments the content segments yet to be verified due to non-overlapping content can be used in the content rendering.

In some embodiments the duration of the segment window can be controlled by visual information related to visual shot boundary information. For example, there may be a list of locations that possibly contain shot boundary information that is also to be detected from the audio scene point of view. For example visual shot boundaries can be determined by monitoring key frame (I-frame) frequency and when a key frame does not follow its natural frequency the position is marked as possible shot boundary. Typically, video encoders enter key frame at periodic interval (say one every 2 sec) and if a key frame is found that does not follow this, then it is possible that that particular point represents video editing point in the content.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings.

Although the above has been described with regards to audio signals, or audio-visual signals it would be appreciated that embodiments may also be applied to audio-video signals where the audio signal components of the recorded data are processed in terms of the determining of the base signal and the determination of the time alignment factors for the remaining signals and the video signal components may be synchronised using the above embodiments of the invention. In other words the video parts may be synchronised using the audio synchronisation information.

It shall be appreciated that the term user equipment is intended to cover any suitable type of wireless user equipment, such as mobile telephones, portable data processing devices or portable web browsers.

Furthermore elements of a public land mobile network (PLMN) may also comprise apparatus as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-27. (canceled)

28. An Apparatus comprising at least one processor and at least one memory including computer code for one or more programs, the at least one memory and the computer code configured to with the at least one processor cause the apparatus to at least:
receive an audio signal comprising at least two audio shots separated by an audio shot boundary;
compare the audio signal against a reference audio signal; and
determine a location of the audio shot boundary within the audio signal based on the comparison of the audio signal against the reference audio signal.

29. The apparatus as claimed in claim 28, further caused to divide the audio signal at the location of the audio shot boundary to form two separate audio signal parts.

30. The apparatus as claimed in claim 29, further caused to align at least one of the two separate audio signal parts based on the reference audio signal to generate a common time line model.

31. The apparatus as claimed in claim 28, wherein the apparatus caused to compare the audio signal against a reference audio signal is further caused to select a reference audio signal from at least one of:
a verified audio signal located on a common time line; and
an initial audio signal for defining a common time line.

32. The apparatus as claimed in claim 28, wherein the apparatus caused to compare the audio signal against a reference audio signal is further caused to:
align the start of the audio signal against the reference audio signal;
generate from the audio signal an audio signal segment;
determine a correlation value by correlating the audio signal segment against an aligned part of the reference audio signal.

33. The apparatus as claimed in claim 32, wherein the apparatus caused to determine a location of the audio shot boundary within the audio signal based on the comparison of the audio signal against the reference audio signal is further caused to determine a shot boundary location within the audio signal segment where the correlation value differs significantly from a further correlation value determined by correlating the previous audio signal segment against an aligned part of the reference audio signal.

34. The apparatus as claimed in claim 33, wherein the correlation value differs significantly from a further correlation value determined by correlating the previous audio signal segment against an associated aligned part of the reference audio signal where:
the correlation value indicates the audio signal segment is correlated with the aligned part of the reference signal and the further correlation value indicates the previous audio signal segment is uncorrelated with the associated aligned part of the reference signal, or
the correlation value indicates the audio signal segment is uncorrelated with the aligned part of the reference signal and the further correlation value indicates the previous audio signal segment is correlated with the associated aligned part of the reference signal.

35. The apparatus as claimed in claim 33, wherein the apparatus caused to determine a location of the audio shot boundary within the audio signal based on the comparison of the audio signal against the reference audio signal is further caused to:
divide the audio signal segment into two parts;
determine a first part correlation value by correlating a first part audio signal segment against an associated aligned part of the reference audio signal;
determine the audio shot boundary location is within the first part audio signal segment where at least one of the following is true: the first part correlation value indicates the first part audio signal segment is uncorrelated with the associated aligned part of the reference audio signal and the audio segment is uncorrelated with the aligned part of the reference audio signal; and the first part correlation value indicates the first part audio signal segment is correlated with the associated aligned part of the reference audio signal and the audio segment is correlated with the aligned part of the reference audio signal; and
determine the audio shot boundary location is within a second part audio signal segment otherwise.

36. The apparatus as claimed in claim 35, further caused to:
divide the audio signal segment part within which the audio shot boundary location is determined into two further parts;
determine a first further part correlation value by correlating a first further part audio signal segment against an associated aligned part of the reference audio signal; and
determine the audio shot boundary location is within the first further part audio signal segment where at least one of the following is true: the first further part correlation value indicates the first further part audio signal segment is uncorrelated with the associated aligned part of the reference audio signal and the audio segment is uncorrelated with the aligned part of the reference audio signal; and the first further part correlation value indicates the first further part audio signal segment is correlated with the associated aligned part of the reference audio signal and the audio segment is correlated with the aligned part of the reference audio signal; and determine the audio shot boundary location is within a second further part audio signal segment otherwise; and repeat until the apparatus is caused to determine the size of the first part audio signal segment is smaller than a location duration threshold.

37. A method comprising:
receiving an audio signal comprising at least two audio shots separated by an audio shot boundary;
comparing the audio signal against a reference audio signal; and
determining a location of the audio shot boundary within the audio signal based on the comparison of the audio signal against the reference audio signal.

38. The method as claimed in claim 37, further comprising dividing the audio signal at the location of the audio shot boundary to form two separate audio signal parts.

39. The method as claimed in claim 38, further comprising aligning at least one of the two separate audio signal parts based on the reference audio signal to generate a common time line model.

40. The method as claimed in claim 37, wherein comparing the audio signal against a reference audio signal comprises selecting a reference audio signal from at least one of:
a verified audio signal located on a common time line; and
an initial audio signal for defining a common time line.

41. The method as claimed in claim 37, wherein comparing the audio signal against a reference audio signal comprises:
aligning the start of the audio signal against the reference audio signal;
generating from the audio signal an audio signal segment; and
determining a correlation value by correlating the audio signal segment against an aligned part of the reference audio signal.

42. The method as claimed in claim 41, wherein determining a location of the audio shot boundary within the audio signal based on the comparison of the audio signal against the reference audio signal comprises determining a shot boundary location within the audio signal segment where the correlation value differs significantly from a further correlation value determined by correlating the previous audio signal segment against an aligned part of the reference audio signal.

43. The method as claimed in claim 42, wherein the correlation value differs significantly from a further correlation value determined by correlating the previous audio signal segment against an associated aligned part of the reference audio signal may comprise determining the correlation value indicates the audio signal segment is correlated with the aligned part of the reference signal and the further correlation value indicates the previous audio signal segment is uncorrelated with the associated aligned part of the reference signal, or the correlation value indicates the audio signal segment is uncorrelated with the aligned part of the reference signal and the further correlation value indicates the previous audio signal segment is correlated with the associated aligned part of the reference signal.

44. The method as claimed in claim 42, wherein determining a location of the audio shot boundary within the audio signal based on the comparison of the audio signal against the reference audio signal may comprise:
dividing the audio signal segment into two parts;
determining a first part correlation value by correlating a first part audio signal segment against an associated aligned part of the reference audio signal; and
determining the audio shot boundary location is within the first part audio signal segment where at least one of the following is true: the first part correlation value indicates the first part audio signal segment is uncorrelated with the associated aligned part of the reference audio signal and the audio segment is uncorrelated with the aligned part of the reference audio signal; and the first part correlation value indicates the first part audio signal segment is correlated with the associated aligned part of the reference audio signal and the audio segment is correlated with the aligned part of the reference audio signal; and determining the audio shot boundary location is within a second part audio signal segment otherwise.

45. The method as claimed in claim 44 further comprising:
dividing the audio signal segment part within which the audio shot boundary location is determined into two further parts;
determining a first further part correlation value by correlating a first further part audio signal segment against an associated aligned part of the reference audio signal; and
determining the audio shot boundary location is within the first further part audio signal segment where at least one of the following is true: the first further part correlation value indicates the first further part audio signal segment is uncorrelated with the associated aligned part of the reference audio signal and the audio segment is uncorrelated with the aligned part of the reference audio signal; and the first further part correlation value indicates the first further part audio signal segment is correlated with the associated aligned part of the reference audio signal and the audio segment is correlated with the aligned part of the reference audio signal; and determine the audio shot boundary location is within a second further part audio signal segment otherwise; and repeat until the determining the size of the first part audio signal segment is smaller than a location duration threshold.
